(19) United States
(12) Patent Application Publication
(10) Pub. No.: US 2009/0278749 A1
(43) Pub. Date: Nov. 12, 2009

(54) Decoration Structure with Loop Antenna

(76) Inventor: En-Min Jow, Hsinchu (TW)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 12/169,687

(22) Filed: Jul. 9, 2008

(30) Foreign Application Priority Data
May 6, 2008 (TW) 97207805

(51) Int. Cl. H01Q 1/22

(52) U.S. Cl. 343/702

(57) ABSTRACT

The present invention discloses a decoration structure with a loop antenna, wherein a loop antenna having superior electromagnetic radiation performance is used as the receiving antenna of a GPS device. Further, the present invention adorns and packages the loop antenna into a decorative strap and integrates the strap with the receiving device so as to reduce the receiving device size and convenience the user holding or wearing the receiving device.

### BACKGROUND OF THE INVENTION

1. Field of the Invention

The present invention relates to a decoration structure, particularly to an easy-to-carry about decoration structure having a loop antenna with superior electromagnetic radiation performance.

2. Description of the Prior Art

The current GPS (Global Positioning System)-equipped devices, such as Bluetooth GPS receivers, smart mobile phones and so on, usually adopt a ceramic patch antenna or a folded monopole antenna, as shown in FIG. 1 and FIG. 2.

Refer to FIG. 1, the ceramic patch antenna benefits from its circular polarization. However, the ceramic patch antenna needs a larger ground plane to maintain the superior electromagnetic radiation performances thereof, such as the circular polarization and beamwidth thereof. Thus, the ceramic patch antenna is hard to meet the current trend of making small, slim and lightweight products. Besides, the ceramic patch antenna is disadvantaged by its narrowband characteristic and is likely to be affected by the environmental factors. For example, the hand holding by the user or the body of the user may induce the frequency deviation of the antenna, which will result in a poor signal receiving quality.

Refer to FIG. 2. The folded monopole antenna can reduce the occupied area in the circuit board via collapsing the antenna or an arrangement of an end face of the antenna. However, this type of antenna still needs a given area of cleared ground plane to attain a better electromagnetic radiation performance and a greater bandwidth. Otherwise, the folded monopole antenna will also be affected by the environmental factors, which may result in a poor electromagnetic radiation performance, a frequency deviation, and a degraded signal receiving quality.

### SUMMARY OF THE INVENTION

One objective of the present invention is to provide a decoration structure with a loop antenna to solve the abovementioned problems, wherein a loop antenna having superior electromagnetic radiation performance is used as the receiving antenna of a GPS (Global Positioning System) device. A loop antenna has a broadband characteristic and a fine radiation pattern. Even though the size of a loop antenna is reduced, the loop antenna still keeps its broadband characteristic and fine radiation pattern. Besides, the current distribution on the ground plane is smaller in a loop antenna than in a patch antenna or a monopole antenna. Therefore, the loop antenna is easy to integrate with different circuit boards and able to maintain a superior receiving quality in different environments.

Another objective of the present invention is to reduce the size of the receiving device, wherein the loop antenna is ornamented and packaged into a decorative strap that can integrate with the receiving device, whereby the area originally occupied by the antenna in the circuit board is decreased, and the size of the receiving device is reduced. Further, the decoration structure also conveniences the user to hold or wear the receiving device.

To achieve the abovementioned objectives, one embodiment of the present invention proposes a decoration structure with a loop antenna, which includes: a casing having a printed circuit board thereinside; and a strap integrated with the casing and having a loop antenna thereinside, wherein the loop antenna is electrically connected with the printed circuit board and receives a wireless signal. The loop antenna is electrically connected with printed circuit board via a soldering method or a screwing method. Thereby, the loop antenna can receive and conduct electromagnetic waves and implement the GPS function.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a conventional ceramic patch antenna;

FIG. 2 is a diagram schematically showing a conventional folded monopole antenna;

FIG. 3A is a diagram schematically showing a decoration structure with a loop antenna according to one embodiment of the present invention;

FIG. 3B is a diagram schematically showing a decoration structure with a loop antenna according to another embodiment of the present invention; and

FIG. 4 is a diagram schematically showing a decoration structure with a loop antenna according to a further embodiment of the present invention.

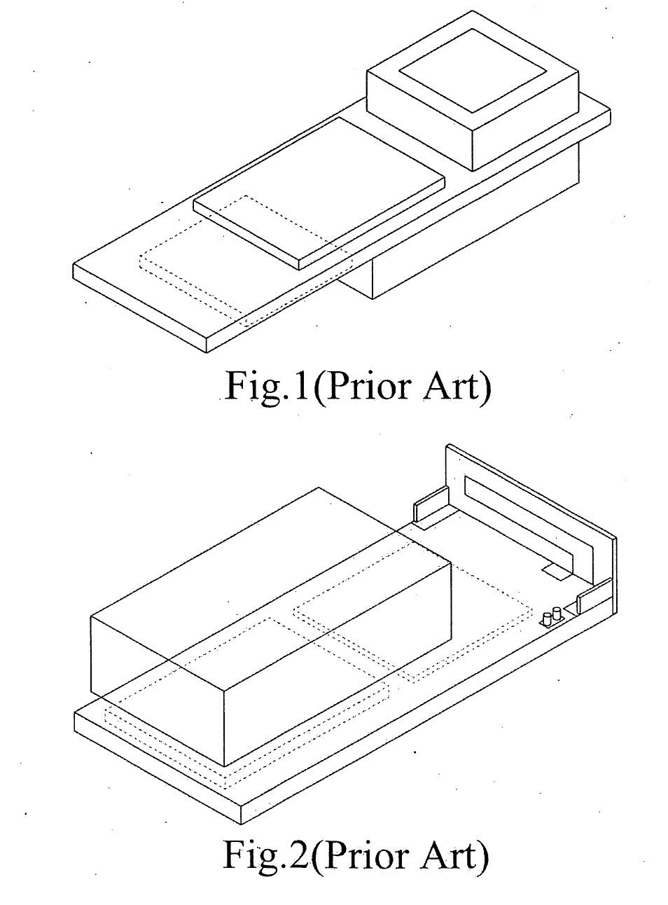

### DETAILED DESCRIPTION OF THE INVENTION

The present invention is described with the embodiments below. However, it should be understood that the embodiments are only to exemplify the present invention but not to limit the scope of the present invention.

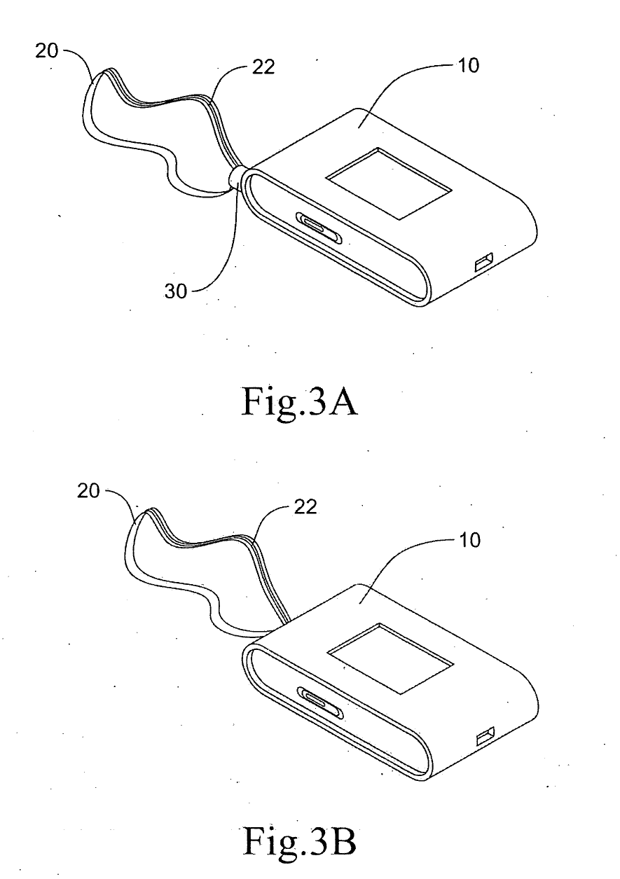

Refer to FIG. 3A a diagram schematically showing a decoration structure with a loop antenna according to one embodiment of to present invention. In this embodiment, the decoration structure with a loop antenna includes: a casing 10 having a printed circuit board (not shown in the drawing) thereinside, and a strap 20 integrating with the casing 10, wherein the strap 20 has a loop antenna 22 thereinside, and the loop antenna 22 is electrically connected with the printed circuit board and receives a wireless signal. The loop antenna 22 may be made of copper. The present invention makes use of the superior electromagnetic radiation performance of the loop antenna 22 to receive wireless signals.

In this embodiment, the decoration structure further includes a connection member 30 in the strap 20, and the connection member 30 is used to connect the strap 20 with the casing 10 via screwing. Herein, the connection member 30 is a screw or a nut, and the casing 10 has a screwing structure (not shown in the drawing) mating with the connection member 30. Alternatively, the connection member 30 may be arranged in the casing 10, and the strap 10 has a screwing structure (not shown in the drawing) mating with the connection member 30. Similarly, the connection member 30 is a screw or a nut. As shown in FIG. 3A, after integrating with the casing 10, the connection member 30 of the strap 20 is partially or totally exposed. In another embodiment, the connection member 30 of the strap 20 is totally screwed into the casing 10 with only the strap 20 exposed, as shown in FIG. 3B. The loop antenna 22 inside the strap 20 is electrically coupled to the printed circuit board inside the casing 10 via the screwing structure (referred to the connection member 30 herein). Thereby, the loop antenna 22 can receive and conduct wireless signals. In addition to using a screwing structure to connect the strap 20 with the casing 10, the printed circuit board inside the casing 10 may further at least have a solder pad where the loop antenna 22 is soldered to and electrically coupled to the printed circuit board.

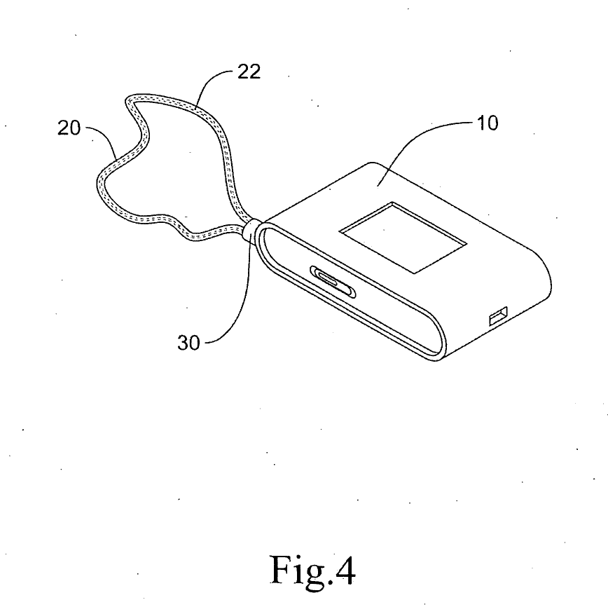

Refer to FIG. 3A and FIG. 3B again, wherein the strap 20 is a flexible board. Refer to FIG. 4 for a further embodiment, wherein the strap 20 is an insulating sleeve, and the loop antenna 22 is encapsulated by the insulating sleeve. Similarly, the loop antenna 22 is directly or indirectly electrically coupled to the printed circuit board in this embodiment. In the present invention, the shape of the casing 10 is not limited by the shapes shown in the drawings but may be a column, a cone, a cube, a sphere, a 3-D geometrical shape, or a 2-D geometrical shape. In the present invention, the decoration structure with a loop antenna is used to receive wireless signals, such as a wireless GPS signal.

The present invention is characterized in that a loop antenna is integrated with a strap to realize the functions of effectively receiving signals and conveniently carrying about the receiving device. The strap is a flexible printed circuit board or an insulating sleeve; the loop antenna is printed on the flexible printed circuit board or inserted into the insulating sleeve; then the loop antenna is electrically coupled to the printed circuit board inside the casing to receive and conduct wireless signals. The strap may be connected with the casing with a screwing method or a soldering method. Therefore, the fabrication process of the present invention has considerable flexibility. Further, the casing may be designed to have different shapes and sizes to attain a decoration effect and an easy-to-carry about function according to users' requirements. Therefore, the present invention is practicable and useful.

In conclusion, the present invention provides a decoration structure with a loop antenna, wherein a loop antenna having superior electromagnetic radiation performance is used as the receiving antenna of a GPS device. A loop antenna has a broadband characteristic and a fine radiation pattern. Even though the size of a loop antenna is reduced, the loop antenna still keeps its broadband characteristic and fine radiation pattern. Besides, the current distribution on the ground plane is smaller in a loop antenna than in a patch antenna or a monopole antenna. Therefore, a loop antenna is easy to integrate with different circuit boards and able to maintain a superior signal receiving quality in different environments. Further, the present invention adorns and packages the loop antenna into a decorative strap and integrates the strap with the receiving device, whereby the area originally occupied by the antenna is decreased, and the size of the receiving device is reduced. Furthermore, the decoration structure also conveniences the user to hold or wear the receiving device.

The embodiments described above are to demonstrate the technical contents and characteristics of the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A decoration structure with a loop antenna comprising:
a casing having a printed circuit board thereinside; and
a strap integrating with said casing, wherein said strap has a loop antenna thereinside, and wherein said loop antenna is electrically coupled to said printed circuit board to receive a wireless signal.

2. The decoration structure with a loop antenna according to claim 1, further comprising a connection member formed on said strap.

3. The decoration structure with a loop antenna according to claim 2, wherein said connection member is used to connect said strap with said casing in a screwing method.

4. The decoration structure with a loop antenna according to claim 2, wherein said connection member is a nut or a screw.

5. The decoration structure with a loop antenna according to claim 4, wherein said casing has a screwing structure mating with said connection member.

6. The decoration structure with a loop antenna according to claim 1, further comprising a connection member formed on said casing.

7. The decoration structure with a loop antenna according to claim 6, wherein said connection member is a nut or a screw.

8. The decoration structure with a loop antenna according to claim 7, wherein said strap has a screwing structure mating with said connection member.

9. The decoration structure with a loop antenna according to claim 1, wherein said printed circuit board has at least one solder pad, and said loop antenna is soldered to said solder pad.

10. The decoration structure with a loop antenna according to claim 1, wherein said strap is a flexible board.

11. The decoration structure with a loop antenna according to claim 1, wherein said strap is an insulating sleeve.

12. The decoration structure with a loop antenna according to claim 1, wherein said wireless signal comprises a GPS (Global Positioning System) signal.

13. The decoration structure with a loop antenna according to claim 1, wherein said casing has a shape of a column, a cone, a cube, a sphere, a 3-D geometrical shape, or a 2-D geometrical shape.
